(19) United States
(12) Patent Application Publication
(10) Pub. No.: US 2026/0177963 A1
(43) Pub. Date: Jun. 25, 2026

(54) IMAGE FORMING APPARATUS

(71) Applicant: SHARP KABUSHIKI KAISHA, Osaka (JP)

(72) Inventor: TATSUYA FUJISAKI, Osaka (JP)

(21) Appl. No.: 19/407,602

(22) Filed: Dec. 3, 2025

(30) Foreign Application Priority Data
Dec. 25, 2024 (JP) 2024-228107

(51) Int. Cl. G03G 15/00

(52) U.S. Cl. CPC G03G 15/5029; G03G 15/502; G03G 15/6502; G03G 15/6594; G03G 2215/00447; G03G 2215/00599

(57) ABSTRACT

An image forming apparatus includes an image former, a feed tray, and a sheet feeder that feeds a sheet to the image former, wherein, when an image forming instruction is input to perform image formation for a plurality of sets in each of which image formation is performed on a plurality of sheets, the sheet is fed from a predetermined feed tray to the image former, and when the sheet in the predetermined feed tray runs out in the middle of the image formation in the image forming instruction, image forming operation is stopped, and in a case where the sheet in the predetermined feed tray runs out when a final sheet of a predetermined set in the image forming instruction is fed to the image former, the sheet is fed from another feed tray different from the predetermined feed tray to the image former and the image forming operation is continued.

### FIELD OF THE INVENTION

The disclosure relates to an image forming apparatus including a plurality of feed trays.

### BACKGROUND ART

In an image forming apparatus such as a copier, a facsimile apparatus, a printer, or a multifunction peripheral, when a paper-out state occurs, a user is notified of occurrence of the paper-out state by displaying the occurrence of the paper-out state on a display, for example. Further, there is also an image forming apparatus that displays a method of restocking a sheet in addition to simply notifying the user of the paper-out state.

Here, even in a case where sizes of sheets are the same, for example, when the sheets are from different manufacturers, even the same white sheets have different types of paper, and the white sheets may be different in paper quality such as gloss or the color tones. In addition, even the same manufacturer may handle sheets of different paper qualities. For example, in a case where a material that is one set of a plurality of sheets is printed, image formation is to be performed on each of the plurality of sheets, but even in a case where the paper-out state occurs in the middle and a user restocks the sheet, when the sheet of a type different from a type of a page that is already printed is restocked, the type of sheet is changed in the middle even though the material is one set, and a problem occurs in that a person who uses the material may feel uncomfortable.

As an image forming apparatus capable of preventing such a problem, there is known an image forming apparatus that, when a user restocks a sheet after a paper-out state occurs, determines whether the restocked sheet is different from the sheet used immediately before the paper-out state or not, and when both are different from each other, displays the difference, and confirms with the user that printing may be continued as is.

According to an image forming apparatus, when a type of paper of a restocked sheet is different from a type of paper of a sheets before a paper-out state, a user is notified of the difference, and thus the user recognizes that the types of paper are different from each other and is to restock a sheet having the same type as that of the sheet before the paper-out state, and thus it is possible to prevent occurrence of a problem in which a type of paper is changed in the middle of a material. Note that when a change of type of paper in the middle of one material is accepted, a user can select printing without restocking a sheet.

### SUMMARY

### Technical Problem

Here, there is also an image forming apparatus that includes a plurality of feed trays and in which an automatic tray switching function can be set to, when a sheet held in a feed tray that feeds the sheet runs out, switch to another feed tray and feeds the sheet from the other feed tray to continue image forming operation continuously. In such an image forming apparatus, as far as the automatic tray switching function is set, printing work can be performed without stopping sequential printing on a plurality of sheets.

However, in a case where a feed tray is switched, when the paper types of sheets held in the feed tray before the switching and a feed tray after the switching are different from each other, a problem occurs in that the type of paper is changed in the middle of sequential printing on a plurality of sheets.

The disclosure is made in view of the above circumstances, and an object thereof is to provide an image forming apparatus capable of easily avoiding a difference in type of sheet in the middle of image formation on a plurality of sheets.

### Solution to Problem

An image forming apparatus according to an aspect of the disclosure is an image forming apparatus that includes an image forming device that forms an image on a sheet, a plurality of feed trays each holding the sheet, and a sheet feeding device that draws out the sheet one at a time from the feed tray and feeds the sheet to the image forming device, wherein in a case where an image forming instruction is input to perform image formation for a plurality of sets in each of which image formation is performed on a plurality of the sheets, the sheet feeding device feeds the sheet from a predetermined feed tray to the image forming device, in a case where the sheet held in the predetermined feed tray runs out in the middle of the image formation in the image forming instruction, the image forming device stops image forming operation, and in a case where a final sheet of a predetermined set in the image forming instruction is fed to the image forming device, and the sheet in the predetermined feed tray runs out, the sheet feeding device feeds the sheet from another feed tray different from the predetermined feed tray to the image forming device and the image forming device continues the image forming operation.

In this way, when the sheet held in the predetermined feed tray runs out in the middle of the image formation, the image forming operation is stopped, but when the final sheet of the set is fed to the image forming device and the sheet in the predetermined feed tray runs out, the sheet is fed from the other different feed tray to the image forming device to continue the image forming operation, so that in a case where a feed tray automatic switching function of, when the sheet held in a feed tray runs out, feeding the sheet from another feed tray is performed and in a case where sheets of paper qualities different from each other are held in respective feed trays, it is possible to suppress a problem that the sheets of different paper qualities are mixed in the same set. Further, work can be efficiently performed by performing the feed tray automatic switching function.

Note that performing image formation for a plurality of sets in each of which image formation is performed on a plurality of sheets means, for example, performing image formation on a plurality of copies of materials each including a plurality of sheets.

In addition, in the above image forming apparatus, cover sheet setting to set a first sheet as a cover sheet in a case where image formation is performed on the plurality of sheets is allowed, in a case where the image forming instruction is input to perform the image formation for a plurality of sets in each of which the image formation is performed on the plurality of sheets for which the cover sheet setting is made, the sheet feeding device may feed the sheet from a predetermined feed tray to the image forming device, and in a case where, in the middle of the image formation in the image forming instruction, the sheet held in the predetermined feed tray runs out due to the sheet on which the image formation is performed as the cover sheet being fed from the predetermined feed tray, the sheet feeding device may feed the sheet from another feed tray different from the predetermined feed tray to the image forming device, and the image forming device may continue the image forming operation.

This can prevent a problem that sheets of different paper qualities are mixed in the sheets other than a cover sheet in a set regardless of the cover sheet setting. Further, work can be efficiently performed by performing the feed tray automatic switching function.

Another image forming apparatus according to an aspect of the disclosure is an image forming apparatus that includes an image forming device that forms an image on a sheet, a plurality of feed trays each holding the sheet, and a sheet feeding device that feeds the sheet one at a time from the feed tray and feeds the sheet to the image forming device, wherein the plurality of feed trays include a plurality of combinations of the plurality of feed trays, the combination holding the plurality of sheets of an identical size, and the sheet of a different size is held in the feed tray of a different combination, in a case where an image forming instruction is input to perform image formation for a plurality of sets in each of which the image formation is performed on the plurality of sheets in which the plurality of sheets of a plurality of sizes different from each other are mixed, the sheet feeding device feeds the sheet from a predetermined feed tray to the image forming device according to the size of the sheet in the image forming instruction, and in a case where, in the middle of the image formation for a predetermined set in the image forming instruction, the sheet held in the predetermined feed tray runs out, and the image formation on the sheet of an identical size to that of the sheet running out is not ended, the image forming device stops image forming operation.

Accordingly, in a case where the sheets of different sizes are held in the plurality of feed trays, and the feed tray automatic switching function is performed in which the sheet held in a feed tray runs out and the sheet is fed from another feed tray, it is possible to suppress a problem that the sheets of different paper qualities are mixed in the sheets having an identical size in a set since the sheets of paper qualities different from each other are held in the feed trays. Further, work can be efficiently performed by performing the feed tray automatic switching function.

In addition, in the above image forming apparatus, in a case where, in the middle of the image formation for the predetermined set in the image forming instruction, the sheet held in the sheet tray in the predetermined feed tray runs out, and the image formation on the sheet of an identical size to that of the sheet running out is ended, the sheet feeding device may feed the sheet to the image forming device from another feed tray that is different from the predetermined feed tray and holds the sheet of an identical size, and the image forming device may continue the image forming operation.

Accordingly, in a case where the feed tray automatic switching function is performed in which the sheets of different sizes are held in the plurality of feed trays and the sheet held in a feed tray runs out and the sheet is fed from another feed tray, the sheet may have a different paper quality for each set since the sheets of paper qualities different from each other are held in the feed trays, but it is possible to suppress a problem that the sheets of different paper qualities are mixed in the sheets having an identical size in a set. Further, work can be efficiently performed by performing the feed tray automatic switching function.

Further, the above image forming apparatus may include a display device, and in a case where the image forming device stops the image forming operation in the middle of the image formation, the display device may perform display relating to a handling method.

This enables a user to recognize the handling method after the image forming operation is stopped, and to efficiently perform work.

### Advantageous Effects of Disclosure

According to the disclosure, it is possible to provide an image forming apparatus that can easily avoid a situation in which a type of sheet is different in the middle of image formation on a plurality of sheets.

### BRIEF DESCRIPTION OF THE DRAWINGS

FIG. 1 is a perspective front view illustrating a schematic formation of an image forming apparatus according to an embodiment of the disclosure.

FIG. 2 is an external view of an operation panel of the image forming apparatus according to the embodiment of the disclosure.

FIG. 3 is a block diagram schematically illustrating a control formation of the image forming apparatus according to the embodiment of the disclosure.

FIG. 4 is an external view when the operation panel of the image forming apparatus according to the embodiment of the disclosure prompts sheet restocking.

FIG. 5 is a flowchart illustrating one example of operation of the image forming apparatus according to the embodiment of the disclosure.

FIG. 6 is a diagram for explaining Example 1 in which the image forming apparatus according to the embodiment of the disclosure is used.

FIG. 7 is a diagram for explaining Example 2 in which the image forming apparatus according to the embodiment of the disclosure is used.

FIG. 8 is a diagram for explaining Example 3 in which the image forming apparatus according to the embodiment of the disclosure is used.

FIG. 9 is a diagram for explaining Example 4 in which the image forming apparatus according to the embodiment of the disclosure is used.

FIG. 10 is a diagram for explaining Example 5 in which the image forming apparatus according to the embodiment of the disclosure is used.

### DESCRIPTION OF EMBODIMENTS

An embodiment according to the disclosure will be described with reference to the drawings.

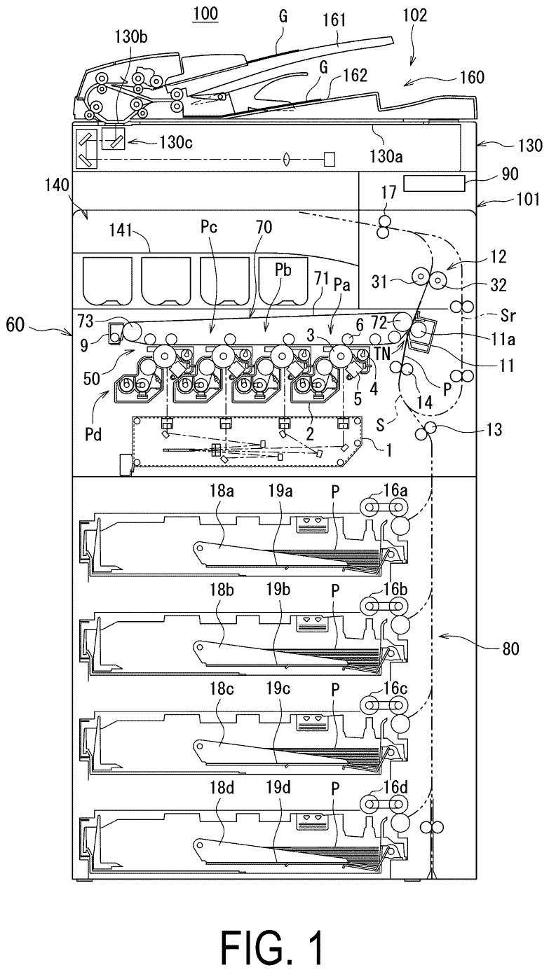

An image forming apparatus according to the embodiment of the disclosure will be described with reference to the drawings. FIG. 1 is a perspective front view illustrating a schematic formation of the image forming apparatus according to the embodiment of the disclosure.

An image forming apparatus 100 is a multifunction peripheral having a copy function, a scanner function, a facsimile function, and a printer function, and including an image reading apparatus 102 and an image forming apparatus body 101.

The image reading apparatus 102 includes an image reader 130 and a document feeding apparatus 160 (automatic document feeding apparatus (ADF)). The document feeding apparatus 160 is provided on an upper side of the image reader 130, and is supported so as to be freely openable and closable with respect to the image reader 130.

The document feeding apparatus 160 conveys one or a plurality of documents G one by one in order. The image reading apparatus 102 reads the documents G conveyed one by one by the document feeding apparatus 160.

The image reader 130 includes a document table 130a on which the document Gis placed, a document reader 130b, and a scanning optical system 130c that reads the document.

When the document feeding apparatus 160 is opened, the document table 130a above the image reader 130 is opened, and the document G can be manually placed thereon. Further, the document feeding apparatus 160 includes a document placement tray 161 on which the document G is placed and a document discharge tray 162 in which the documents G having been discharged outside are stacked.

In the image forming apparatus 100, the document feeding apparatus 160 conveys the document G placed on the document placement tray 161 onto the document reader 130b in the image reader 130. The image reader 130 scans the scanning optical system 130c to read the document placed on the document table 130a or reads the document G conveyed by the document feeding apparatus 160 to generate image data.

The image forming apparatus body 101 includes an image transferrer 50, an optical scanning apparatus 1, an intermediate transfer belt apparatus 70, a secondary transfer apparatus 11, a fixing apparatus 12, a sheet conveyance path S, feed trays 18a to 18d, and a sheet discharge tray 141. In particular, the image transferrer 50, the optical scanning apparatus 1, the intermediate transfer belt apparatus 70, the secondary transfer apparatus 11, and the fixing apparatus 12 form an image former 60. The image former 60 forms an image on a front surface of a sheet P with toner.

The image forming apparatus 100 handles image data corresponding to a color image composed of colors black (K), cyan (C), magenta (M), and yellow (Y), or a monochrome image composed of a single color (black, for example).

The image transferrer 50 of the image forming apparatus 100 includes four image stations Pa, Pb, Pc, and Pd corresponding to the respective colors of black, cyan, magenta, and yellow. Each of the image stations Pa, Pb, Pc, and Pd includes a development apparatus 2, a photoreceptor drum 3, a drum cleaning apparatus 4, and a charger 5, whereby four types of toner images are formed by the image stations Pa, Pb, Pc, and Pd. That is, in the image forming apparatus 100, four sets of the development apparatus 2, the photoreceptor drum 3, the drum cleaning apparatus 4, and the charger 5 are provided, and these sets respectively correspond to black, cyan, magenta, and yellow.

The optical scanning apparatus 1 exposes a front surface of the photoreceptor drum 3 to form an electrostatic latent image. The development apparatus 2 develops the electrostatic latent image on the front surface of the photoreceptor drum 3 to form a toner image on the front surface of the photoreceptor drum 3. The drum cleaning apparatus 4 removes and collects a residual toner on the front surface of the photoreceptor drum 3. The charger 5 uniformly charges the front surface of the photoreceptor drum 3 to a predetermined potential. With the series of operations described above, the toner images of the respective colors are formed on the front surfaces of the respective photoreceptor drums 3.

The intermediate transfer belt apparatus 70 includes an intermediate transfer roller 6, an intermediate transfer belt 71 having an endless shape, an intermediate transfer driving roller 72, an intermediate transfer driven roller 73, and a cleaning apparatus 9. The intermediate transfer belt 71 is an endless belt capable of moving in a circumvolution manner, and is wound around the intermediate transfer driving roller 72 and the intermediate transfer driven roller 73. That is, the intermediate transfer belt 71 is stretched over the intermediate transfer driving roller 72 and the intermediate transfer driven roller 73. There are four intermediate transfer rollers 6 and are provided on an inner side of the intermediate transfer belt 71 to form four types of toner images corresponding to the respective colors. The intermediate transfer rollers 6 transfer the toner images of the respective colors formed on the front surfaces of the photoreceptor drums 3, to the intermediate transfer belt 71.

In the image forming apparatus 100, the toner images of the respective colors formed on the front surfaces of the respective photoreceptor drums 3 are sequentially transferred and superimposed to form a color toner image on the front surface of the intermediate transfer belt 71 stretched over the intermediate transfer driving roller 72 and the intermediate transfer driven roller 73. The cleaning apparatus 9 removes and collects a waste toner that is not transferred onto the sheet P and remains on the front surface of the intermediate transfer belt 71. Specifically, the cleaning apparatus 9 performs a cleaning operation of removing adhering matter adhering to the intermediate transfer belt 71 after the toner image formed on the intermediate transfer belt 71 is transferred to the sheet P.

The secondary transfer apparatus 11 forms a transfer nip region TN between a secondary transfer roller 11a and the intermediate transfer belt 71, and conveys the sheet P having been conveyed through the sheet conveyance path S while nipping the sheet P in the transfer nip region TN. The secondary transfer roller 11a is disposed to face the intermediate transfer driving roller 72 with the intermediate transfer belt 71 interposed between the secondary transfer roller 11a and the intermediate transfer driving roller 72. When the sheet P passes through the transfer nip region TN, the toner image on the front surface of the intermediate transfer belt 71 is transferred onto the sheet P, and the sheet P is conveyed to the fixing apparatus 12. Note that although not described in detail, when the toner image is transferred from the intermediate transfer belt 71 to the sheet P, the intermediate transfer driving roller 72 and the secondary transfer roller 11a are grounded or electrically biased, for example, so that the negatively charged toner is easily moved from the intermediate transfer belt 71 to the sheet P.

The fixing apparatus 12 includes a fixing roller 31 and a pressure roller 32 that rotate while sandwiching the sheet P. In the fixing apparatus 12, the sheet P with the transferred toner image is nipped between the fixing roller 31 and the pressure roller 32 and subject to heat and pressure to fix the toner image onto the sheet P. Specifically, a heater as a heat source is disposed inside the fixing roller 31, and a front surface of the fixing roller 31 in contact with the sheet P, on which the toner image has been transferred, is heated by heat generated by the heater.

In this manner, an image is formed on the sheet P by the image former 60 including the image transferrer 50, the optical scanning apparatus 1, the intermediate transfer belt apparatus 70, the secondary transfer apparatus 11, and the fixing apparatus 12.

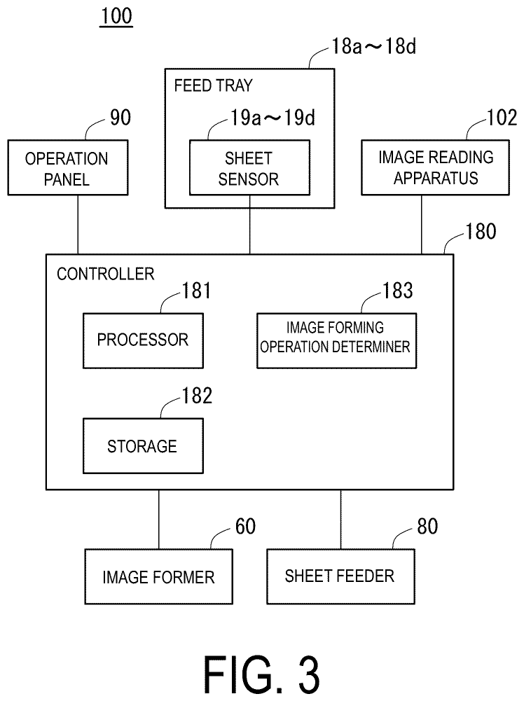

The four feed trays 18a to 18d are each a tray to store the sheet P to be used for image formation, and is provided below the optical scanning apparatus 1. Sheet sensors 19a to 19d to detect whether the sheets P are held in the feed trays 18a to 18d are installed in the feed trays 18a to 18d, respectively, and when the sheet P held runs out in each of the feed trays 18a to 18d, a signal is transmitted from the sheet sensors 19a to 19d to at least one controller 180 (see FIG. 3) to be described below. Note that a signal may be transmitted when the sheet P is held.

Additionally, pickup rollers 16a to 16d to pull out the sheets P are installed in the feed trays 18a to 18d, respectively. The sheets P held in the feed trays 18a to 18d are pulled out by the pickup rollers 16a to 16d, respectively, and are conveyed to the sheet conveyance path S. The sheet P conveyed to the sheet conveyance path S is conveyed to discharge rollers 17 via the secondary transfer apparatus 11 and the fixing apparatus 12, and is discharged to the sheet discharge tray 141 at a discharge portion 140.

Here, the sheets P of different sizes may be held in the respective feed trays 18a to 18d as described above, or the sheets P of the same size may be held. In the embodiment, the sheets P of an A4 size are held in the feed tray 18a and the feed tray 18b, and the sheets P of an A3 size are held in the feed tray 18c and the feed tray 18d. However, the sheets P held in the feed tray 18a and the feed tray 18b have the same size but different paper qualities, and the sheets P held in the feed tray 18c and the feed tray 18d also have the same size but different paper qualities. Since the paper qualities are different, gloss and color tones are different even in the same white color. Further, the size of the sheet P held in each of the feed trays 18a to 18d is registered and stored in a storage 182 described below.

Conveying rollers 13, registration rollers 14, and the discharge rollers 17 are arranged along the sheet conveyance path S. The conveying rollers 13 assist the conveyance of the sheet P. The registration rollers 14 temporarily stop the sheet P and align a leading end of the sheet P. Further, the registration rollers 14 convey the temporarily stopped sheet P in synchronization with timing of a color toner image on the intermediate transfer belt 71. As described above, the color toner image on the intermediate transfer belt 71 is transferred onto the sheet P in the transfer nip region TN between the intermediate transfer belt 71 and the secondary transfer roller 11a.

Further, when the image forming apparatus 100 forms images on both the front surface and a back surface of the sheet P, the sheet P is conveyed in a reverse direction from the discharge rollers 17 to a sheet reverse path Sr. The image forming apparatus 100 inverts the front and back of the sheet P conveyed in the reverse direction and guides the sheet P again to the registration rollers 14. Further, the image forming apparatus 100 forms an image on the back surface of the sheet P guided to the registration rollers 14 in a similar manner to when forming an image on the front surface, and discharges the sheet P to the sheet discharge tray 141.

Here, the pickup rollers 16a to 16d, the conveying rollers 13, and the registration rollers 14 form a sheet feeder 80 that conveys the sheets P from the feed trays 18a to 18d to the image former 60.

In addition, the image forming apparatus 100 has a feed tray automatic switching function. In particular, a so-called auto tray switch function is included that is a function, when the sheet P runs out in any one of the feed trays 18a to 18d that feed the sheets P to the image former 60, to continue image forming operation without stopping the image forming operation by feeding the sheets P from the different feed trays 18a to 18d. However, according to the image forming apparatus 100 of the embodiment, the feed tray automatic switching function is performed as long as a predetermined condition is satisfied, but the feed tray 18 is not automatically switched in other cases.

Further, the image forming apparatus 100 includes an operation panel 90. Note that although FIG. 1 is a perspective view, the operation panel 90 is installed outside the image forming apparatus 100 and can be operated by a user. The operation panel 90 is a touch panel display, and displays an image indicating a button related to an operation, and the user can perform an input related to an operation by touching the touch panel display. For example, the image forming apparatus 100 can be caused to operate by operating the operation panel 90. Further, by operating the operation panel 90, it is also possible to register the size of the sheet P held in each of the feed trays 18a to 18d. Further, by operating the operation panel 90, it is also possible to set performance of the feed tray automatic switching function. Further, the operation panel 90 can also display a preview of a document, an image, or the like to be printed. Note that the operation panel 90 may include a software keyboard or the like in addition to the touch panel display.

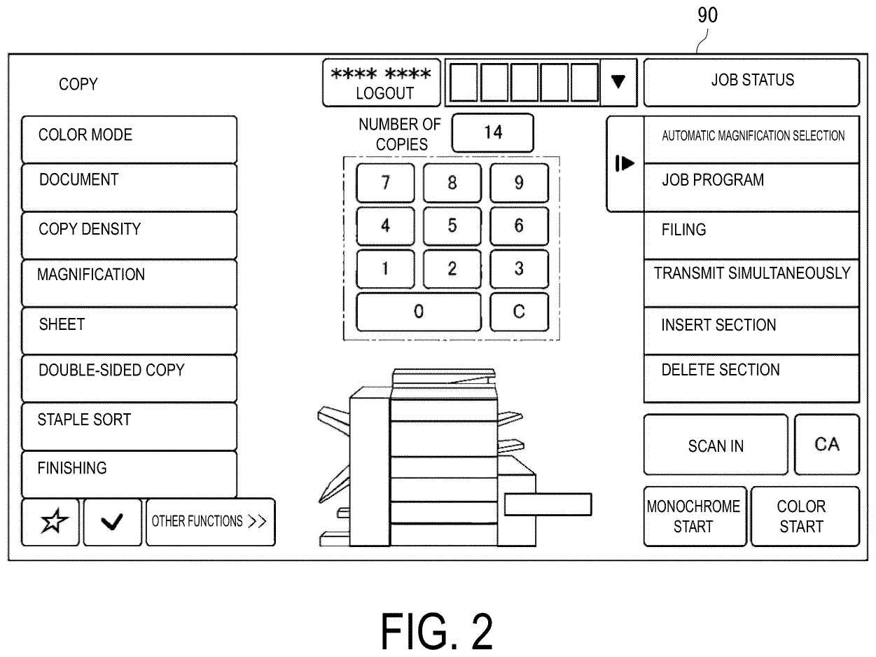

Here, an appearance of the operation panel 90 of the image forming apparatus 100 will be described with reference to the drawing. FIG. 2 is an external view of the operation panel of the image forming apparatus according to the embodiment of the disclosure.

As illustrated in FIG. 2, various buttons to operate the image forming apparatus 100 are displayed on the operation panel 90, and the user can perform various types of settings by touching the buttons (display surface). For example, by operating the operation panel 90, printing (image formation) can be performed on the sheets P of the A4 and A3 sizes. Further, it is possible to perform printing (image formation) on a plurality of the sheets P with the sheets P of the A4 and A3 sizes mixed. For example, printing can be performed on a first sheet of the A4 size, a second sheet of the A3 size, a third sheet of the A4 size, and a fourth sheet of the A3 size, to perform printing on a total of four sheets P. Further, with the four sheets as a set, printing can be performed for a plurality of sets. That is, by performing printing on a first sheet of the A4 size, a second sheet of the A3 size, a third sheet of the A4 size, and a fourth sheet of the A3 size, and further performing printing on four sheets in the same manner, printing can be performed for two copies. Note that in this case, the image formation is performed on eight sheets P, and the image forming operation is ended.

Further, the user can set whether to perform the feed tray automatic switching function or not by operating the operation panel 90. When the performance of the feed tray automatic switching function is not set by the operation panel 90, the image forming operation is stopped when the sheet P runs out in any of the feed trays 18a to 18d that feed the sheets P during the image forming operation of the image former 60. In this case, it is sufficient to perform a display for notifying the user that the sheet P runs out on the operation panel 90. In addition, when the performance of the feed tray automatic switching function is set by the operation panel 90, and the sheet P runs out in any one of the feed trays 18a to 18d that feed the sheets P during the image forming operation of the image former 60, switching is performed so that the sheets P are fed from the other feed trays 18a to 18d that hold the sheets P of the same size, and the image forming operation is continued without stopping. However, depending on a condition, even when the performance of the feed tray automatic switching function is set, the image forming operation is stopped. Details of the condition will be described below.

Next, a control formation of the image forming apparatus 100 will be described with reference to the drawing. FIG. 3 is a block diagram schematically illustrating the control formation of the image forming apparatus according to the embodiment of the disclosure.

As illustrated in FIG. 3, the image forming apparatus 100 includes, other than the above, the at least one controller 180 that is responsible for the entire control of the image forming apparatus 100. Note that in FIG. 3, members related to the control in the image forming apparatus 100 are illustrated, and illustration of other members is omitted.

The at least one controller 180 is, for example, a microcomputer such as a Central Processor Unit (CPU), and includes storage apparatuses such as a Read Only Memory (ROM), a Random Access Memory (RAM), and a data rewritable nonvolatile memory. The storage 182 includes these storage apparatuses.

The storage 182 stores in advance a program and the like to control the operation of the image forming apparatus 100. Further, the storage 182 stores data relating to images and documents formed by the image former 60 when the image forming apparatus 100 performs the image forming operation, and stores data read by the image reading apparatus 102, and the like.

Further, the storage 182 also stores a state set by the user by the operation panel 90. For example, when the feed tray automatic switching function is set, the setting is stored. In addition, when the size of the sheet P held in each of the feed trays 18a to 18d is set by the user, the storage 182 stores the size of the sheet P held in each of the feed trays 18a to 18d.

The at least one controller 180 enables functions of a processor 181 and an image forming operation determiner 183 by executing a control program stored in advance in the storage 182. Further, the storage 182 provides the processor 181 with a work area for work, and regions as an image memory to store image data and a memory to store document data.

The processor 181 executes the control program stored in advance in the storage 182, thereby performing operation control of various components. For example, the image former 60 and the sheet feeder 80 are controlled by the processor 181. Further, the processor 181 receives signals from the operation panel 90 and the sheet sensors 19a to 19d of the feed trays 18a to 18d.

Note that the at least one controller 180 may be achieved by one or a plurality of control apparatuses/arithmetic apparatuses (CPU, System on a Chip (SoC)). In addition, the at least one controller 180 may include one or a plurality of control circuits.

The image forming operation determiner 183 determines whether to perform (continue) or stop the image forming operation according to a print instruction (image forming instruction) for the sheet P set by the operation panel 90 and states of the sheets P held by the respective feed trays 18a to 18d detected by the sheet sensors 19a to 19d. In accordance with the determination of the image forming operation determiner 183, it is determined whether to perform the image forming operation in the image former 60 or not, and the processor 181 instructs the operation of the image former 60 and the sheet feeder 80. Note that the image former 60 and the sheet feeder 80 operate in accordance with an instruction from the processor 181. Specifically, the image transferrer 50, the intermediate transfer belt apparatus 70, the secondary transfer apparatus 11, and the fixing apparatus 12 in the image former 60 are caused to operate. Further, the pickup rollers 16a to 16d, the conveying rollers 13, and the registration rollers 14 are caused to drive. That is, driving motors to cause various rollers and the like to drive are controlled to operate.

For example, when the user operates the operation panel 90 to instruct image formation (printing) on the sheet P, the processor 181 causes the image former 60 and the sheet feeder 80 to operate based on a signal from the operation panel 90 to perform the image forming operation instructed. Note that whether to perform the image forming operation or not is determined by the image forming operation determiner 183.

Here, in a case where the performance of the feed tray automatic switching function is set, when the user operates the operation panel 90 to instruct to perform sequential printing on a plurality of sheets (set) for one set or a plurality of sets, and the image forming operation by the image former 60 is started, and when the sheet P runs out in any of the feed trays 18a to 18d that feed the sheets P to the image former 60, the image forming operation determiner 183 determines whether to continue or stop the image forming operation. The processor 181 performs continuation or stop of the image forming operation according to the determination of the image forming operation determiner 183.

Hereinafter, the determination of the continuation and the stop of the image forming operation by the image forming operation determiner 183 when the performance of the feed tray automatic switching function is set will be described.

First, a case will be described where the print instruction is an instruction to perform printing on a plurality of sets (for example, two copies), where image formation on a plurality of sheets P of the same size (here, the A4 size) is defined as one set (one copy). That is, this is a case where two copies of a material including a plurality of sheets are printed. For example, a case will be described where, when the image forming operation is started, the sheet P of the A4 size is fed from the feed tray 18a to the image former 60 by the sheet feeder 80 (the pickup roller 16a, the conveying rollers 13, and the registration rollers 14), and the sheet P held in the feed tray 18a runs out in the middle of image formation in the image former 60. Note that the sheet sensor 19a detects that the sheet P held in the feed tray 18a runs out, and transmits a signal of the detection to the at least one controller 180.

In a case where the sheet P when the sheet P held in the feed tray 18a runs out is a final page of a first set, that is, in a case where the sheet P held in the feed tray 18a runs out when the sheet P corresponding to the final page of the first set is fed to the image former 60, the image forming operation determiner 183 determines to feed the sheet P from the feed tray 18b holding the sheet P of the A4 size to the image former 60 and continue the image forming operation. Then, the processor 181 causes the pickup roller 16b, the conveying rollers 13, and the registration rollers 14 to operate to feed the sheet P from the feed tray 18b to the image former 60. As a result, a first sheet P of a second copy is fed from the feed tray 18b. Therefore, even when the sheets P held in the feed tray 18a and the sheets P held in the feed tray 18b have different paper qualities, all pages in the first set are formed of the sheets P having the same paper quality, and all pages in the second set are formed of the sheets P having the same paper quality. This prevents a problem that the paper quality is different in the middle of a material formed of a plurality of sheets. Note that since the feed trays 18a and 18b that feed the sheets for the first set and the second set are different from each other, the paper qualities may be different from each other.

On the other hand, in a case where the sheet P when the sheet P held in the feed tray 18a runs out is not the final page of the first set, that is, in a case where the sheet P held in the feed tray 18a runs out at timing other than when the sheet P corresponding to the final page of the first copy is fed to the image former 60, the image forming operation determiner 183 determines to stop the image forming operation. Then, the processor 181 stops the operation of the pickup roller 16a, the conveying rollers 13, the registration rollers 14, and the image former 60.

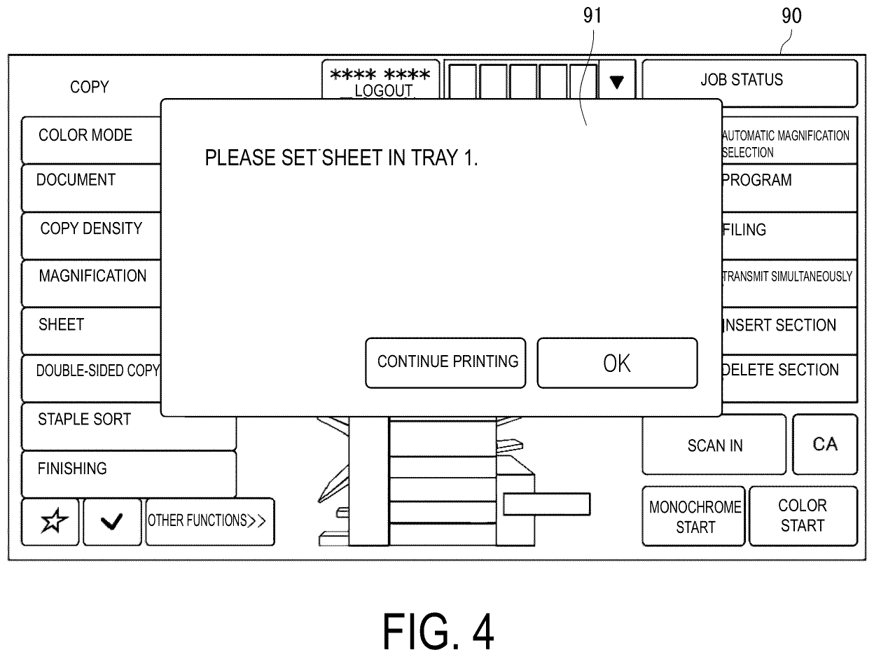

In addition, in this case, it is sufficient to prompt the user to reset the sheet P in the feed tray 18a. For example, it is sufficient to display a notification to prompt restocking of the sheets P on the operation panel 90. This display will be described with reference to the drawing. FIG. 4 is an external view when the operation panel of the image forming apparatus according to the embodiment of the disclosure prompts sheet restocking.

As illustrated in FIG. 4, when the image forming operation determiner 183 determines to stop the image forming operation, the processor 181 displays, on the operation panel 90, a notification display 91 to notify to prompt restocking of the sheets P. Note that in the notification display 91, the user can also select “CONTINUE PRINTING”. When the user selects “CONTINUE PRINTING”, the image forming operation determiner 183 determines to continue the image forming operation by feeding the sheet P from the feed tray 18b in which the sheet P of the A4 size is held to the image former 60. Then, the processor 181 causes the pickup roller 16b, the conveying rollers 13, and the registration rollers 14 to operate to feed the sheet P from the feed tray 18b to the image former 60. Note that when the user selects “OK” in the notification display 91, the image forming operation remains stopped, and the display of the notification display 91 disappears. After that, the user restocks the feed tray 18a with the sheets P, and instructs to resume the image forming operation, so that the image forming operation is continued. Note that at this time, the user restocks the feed tray 18a with the sheets P of the same type (paper quality) as that of the sheets P held before the sheets P in the feed tray 18a run out, thereby preventing the paper quality of the sheets P from being different in the same set.

Thus, according to the image forming apparatus 100 of the embodiment, when the user sets the paper feed tray automatic switching function, and performs printing for a plurality of sets in each of which printing is performed on a plurality of sheets, it is possible to suppress a problem that paper quality changes in the middle of the same material. Further, when paper quality does not change in the same set, the feed tray 18a in which the sheet P runs out is automatically switched to continue the image forming operation, so that work can be efficiently performed. Further, when the user selects “CONTINUE PRINTING” (performance of the feed tray automatic switching function) after the image forming apparatus 100 issues an instruction to restock the sheets P, the image forming operation is continued by switching the feed tray, so that work can be efficiently performed.

Next, a case will be described where the print instruction is an instruction to perform printing for a plurality of sets (for example, two sets), where image formation on a plurality of sheets in which the sheets P having different sizes (here, the A4 size and the A3 size) are mixed is defined as one set. Note that in the embodiment, a case will be described where printing is performed for two sets, where printing on four sheets of a first sheet of the A4 size, a second sheet of the A3 size, a third sheet of the A4 size, and a fourth sheet of the A3 size is defined as one set.

For example, when the image forming operation is started, the sheet P of the A4 size is fed from the feed tray 18a to the image former 60 by the sheet feeder 80 (the pickup roller 16a, the conveying rollers 13, and the registration rollers 14), an image is formed on a first sheet P in the image former 60, then a second sheet P of the A3 size is fed from the feed tray 18c to the image former 60 to form an image, then a third sheet P of the A4 size is fed from the feed tray 18a to the image former 60 to form an image, and a fourth sheet P of the size A3 is fed from the feed tray 18c to the image former 60 to form an image, whereby the printing for a first set is completed. Subsequently, the operation proceeds to printing on a second set. A first sheet P of the A4 size is fed from the feed tray 18a to the image former 60 to form an image, and a second sheet P of the A3 size is fed from the feed tray 18c to the image former 60 and to form an image, but as a result, when the sheet P held in the feed tray 18c runs out, a signal indicating that the sheet P runs out is transmitted from the sheet sensor 19c to the at least one controller 180.

Thereafter, a third sheet P of the A4 size is fed from the feed tray 18a to the image former 60 and image formation is performed, but here, the image forming operation determiner 183 determines to stop the image forming operation, and the image forming operation is stopped by the processor 181. Then, as illustrated in FIG. 4, the notification display 91 is displayed on the operation panel 90. That is, as for the sheets P of the same size in the same set, the sheet is not fed from the different feed tray to perform the image formation.

Note that when the user selects “CONTINUE PRINTING” in the notification display 91, the image forming operation determiner 183 determines to continue the image forming operation by feeding the sheet P from the feed tray 18d in which the sheet P of the A3 size is held to the image former 60. Then, the processor 181 causes the pickup roller 16d, the conveying rollers 13, and the registration rollers 14 to operate to feed the sheet P from the feed tray 18d to the image former 60.

Note that when the user selects “OK” in the notification display 91, the image forming operation remains stopped, and the display of the notification display 91 disappears. After that, the user restocks the feed tray 18c with the sheets P, and instructs to resume the image forming operation, so that the image forming operation is continued.

On the other hand, in the image forming operation on the fourth sheet of the first set, when the fourth sheet P of the A3 size is fed from the feed tray 18c to the image former 60, the sheet P held in the feed tray 18c runs out, and a signal indicating that the sheet P runs out is transmitted from the sheet sensor 19c to the at least one controller 180, the operation proceeds to printing for the second set, and the sheet P of the A4 size of the first sheet is fed from the feed tray 18a to the image former 60 to perform image formation. At this time, although no sheet Pis held in the feed tray 18c, the image forming operation determiner 183 determines to continue the image forming operation. Then, the processor 181 causes the pickup roller 16d, the conveying rollers 13, and the registration rollers 14 to operate to feed the sheet P from the feed tray 18d to the image former 60. As a result, the second sheet P of the second set is fed from the feed tray 18d. Therefore, even when the sheets P held in the feed tray 18c and the sheets P held in the feed tray 18d have different paper qualities, all the pages of the same size in the first set are formed of the sheets P having the same paper quality, and all pages of the same size in the second set are formed of the sheets P having the same paper quality. Thus, it is possible to prevent a problem that paper quality is different in the middle of a material formed of a plurality of sheets. Note that since the feed trays 18a, 18b, 18c, and 18d that feed the sheets are different for the first set and the second set, there is a possibility that paper qualities of the sheets P of the same size are different.

Note that in the above description, the image forming apparatus 100 includes the feed tray 18d in which the recording sheet P of the A3 size is held, but need not include the feed tray 18d, and the sheet P of the A3 size may be placed on a bypass tray (not illustrated). Then, as far as it is registered using the operation panel 90 that the sheet P of the A3 size is placed on the bypass tray, when the sheet P held in the feed tray 18c runs out, and the feed tray automatic switching function is performed, the sheet P placed on the bypass tray is fed to the image former 60.

As described above, according to the image forming apparatus 100 of the embodiment, even when the feed tray automatic switching function is set, in a case where a set including a plurality of sheets P is created by printing for a plurality of the sets, when the sheets P are fed from the different feed trays for each material of the plurality of sets, the image forming operation is stopped before the sheets P are fed, and the user is notified of the stop. This makes it easy to make the sheets P of the same size in the plurality of sets of materials have the same paper quality. Further, when the user does not stick to the same paper quality, the image forming operation can be easily continued as it is, so that the user can efficiently perform work.

Further, according to the image forming apparatus 100 of the embodiment, in a case where printing is performed on a plurality of sheets all having the same size, when the paper-out state occurs in the middle of the same set, the printing is stopped. This prevents paper qualities from being different in the middle of the same set. Further, in a case where the paper-out state occurs for the sheet P of a size for which printing is already performed in the same set, the image forming operation is stopped. This prevents the sheets P of the same size in the same set from having different paper qualities.

Further, according to the image forming apparatus 100 of the embodiment, it is possible to perform cover sheet setting in printing. The cover sheet setting is a function of printing on a specific type of sheet P with a first sheet of a set subjected to printing as a cover sheet. For example, when the sheet P held in the feed tray 18b is set as the cover sheet, the sheet P is normally fed from the feed tray 18a to the image former 60, but the sheet P is fed from the feed tray 18a to the image former 60 for the first sheet of the set.

Note that the user can easily perform the cover sheet setting with the operation panel 90. In a case where the cover sheet setting is made in this manner, and printing is performed on a plurality of sheets P of the same size including the cover sheet, even when the feed tray automatic switching function is set, it is sufficient that the sheet P is fed to the image former 60 from the set feed tray 18b for the cover sheet.

For example, in a case where printing is performed for two sets, where three sheets including a cover sheet form one set, when image formation is performed on a third sheet P of a first set and the sheet P held in feed tray 18a runs out, the sheet P is fed from the feed tray 18b to the image former 60 because a first sheet of a second set is the cover sheet. Then, the image forming operation determiner 183 determines to continue the image forming operation, and the sheets P are fed from the feed tray 18b also for the second and third sheets.

As described above, according to the image forming apparatus 100 of the embodiment, even in a case where the cover sheet setting is made, when the feed tray automatic switching function is set, and the sheet P in the feed tray 18a for which the cover sheet setting is not made runs out, image formation is performed on the sheet P held in the feed tray 18b for which the cover sheet setting is made, and thus printing work can be efficiently performed.

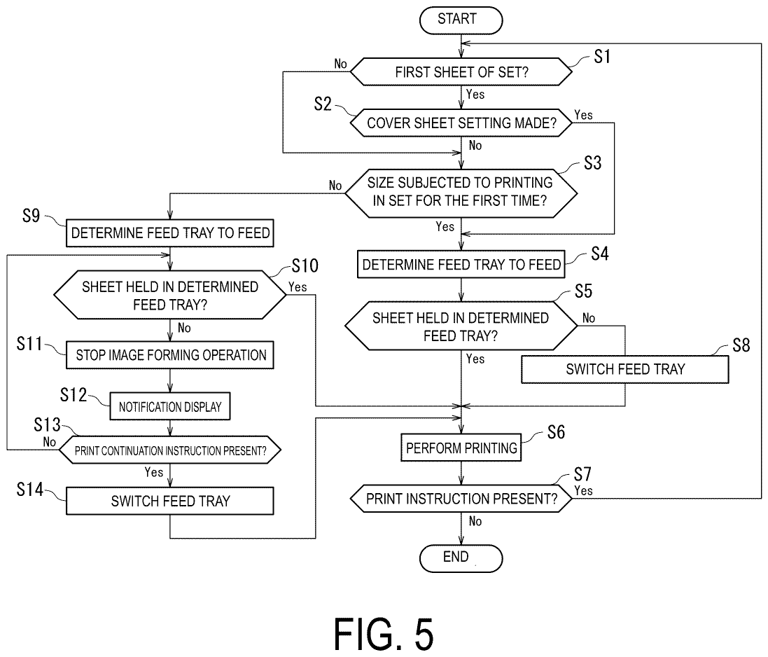

Next, one example of the operation of the image forming apparatus 100 according to the embodiment will be described with reference to the drawings. FIG. 5 is a flowchart illustrating one example of the operation of the image forming apparatus according to the embodiment of the disclosure.

When a print instruction is issued to perform printing of a plurality of sheets for a plurality of sets in a state where the feed tray automatic switching function is set, as illustrated in FIG. 5, the image forming operation determiner 183 determines whether the sheet P for which printing is to be performed (on which an image is to be formed) is a first sheet of a set (step S1). In a case of the first sheet of the set (step S1: Yes), it is determined whether the cover sheet setting is made or not (step S2). In addition, in a case of not the first sheet of the set (step S1: No), the operation proceeds to step S3.

In step S2, when the cover sheet setting is not made (step S2: No), the operation proceeds to step S3, and when the cover sheet setting is made (step S2: Yes), the operation proceeds to step S4.

In step S3, it is determined whether a size is a size for printing for the first time in a set or not (step S3). When the size is the size for printing for the first time (step S3: Yes), a feed tray to feed the sheet P to the image former 60 is determined (step S4). It is sufficient to select the feed tray 18a when the size of the sheet P is A4, or to select the feed tray 18c when the size of the sheet P is A3 to determine the feed tray. Thereafter, it is determined whether the sheet P is held in the determined feed tray (step S5). When the sheet P is not held (step S5: No), the feed tray is switched (step S8) to perform printing (step S6). That is, the processor 181 continues the image forming operation. In addition, also when the sheet P is held (step S5: Yes), printing is performed (step S6).

After step S6, it is determined whether there is a print instruction (step S7), and when there is still a print instruction (step S7: Yes), that is, when there is the sheet P to be subjected to printing, the operation returns to step S1 again, and when there is no print instruction (step S7: No), that is, when there is no sheet P to be subjected to printing, the operation ends.

In addition, in step S3, when the size is not the size for printing for the first time (step S3: No), a feed tray to feed the sheet P to the image former 60 is determined (step S9), and it is determined whether the sheet P is held in the determined feed tray (step S10). When the sheet P is held (step S10: Yes), printing is performed (step S6). That is, the processor 181 continues the image forming operation.

In addition, in step S10, when the sheet P is not held (step S10: No), the processor 181 stops the image forming operation (step S11), and further, displays the notification display 91 on the operation panel 90 (step S12). Then, it is determined whether there is a print continuation instruction (step S13), and when there is a print continuation instruction (step S13: Yes), that is, when the user selects “CONTINUE PRINTING” in the notification display 91, the feed tray is switched (step S14), and printing is performed (step S6). On the other hand, in step S13, when there is no print continuation instruction (step S13: No), that is, when the user selects “OK” without selecting “CONTINUE PRINTING” in the notification display 91, the operation returns to step S10 again.

Here, when the user restocks the determined feed tray with the sheet P (step S10: Yes), the sheet P is fed from the determined feed tray to the image former 60, and printing is performed (step S6).

Hereinafter, specific examples (Examples 1 to 5) when image formation is performed on the sheet P using the image forming apparatus 100 according to the embodiment will be described with reference to the drawings while illustrating comparative examples.

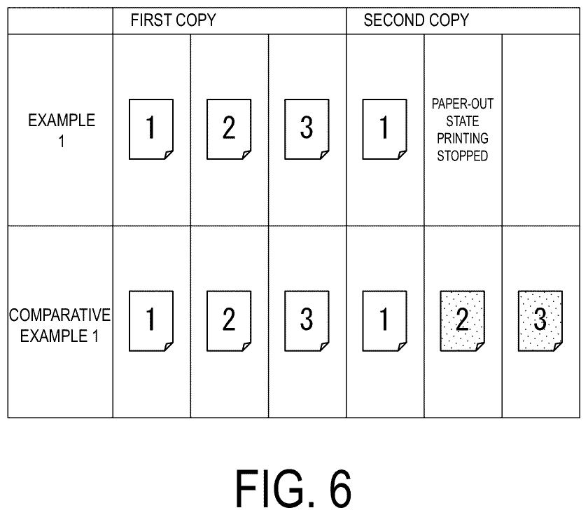

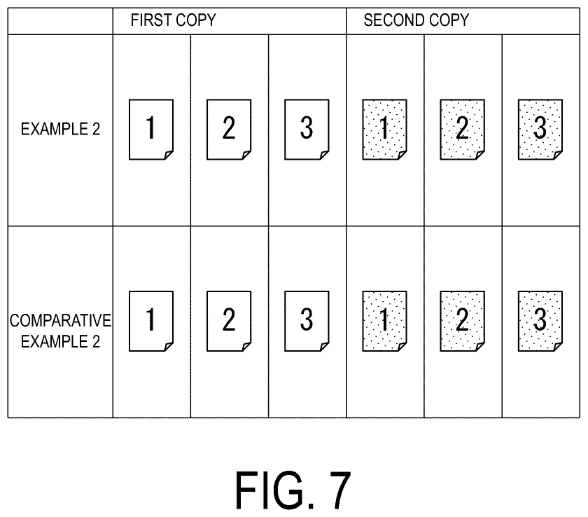

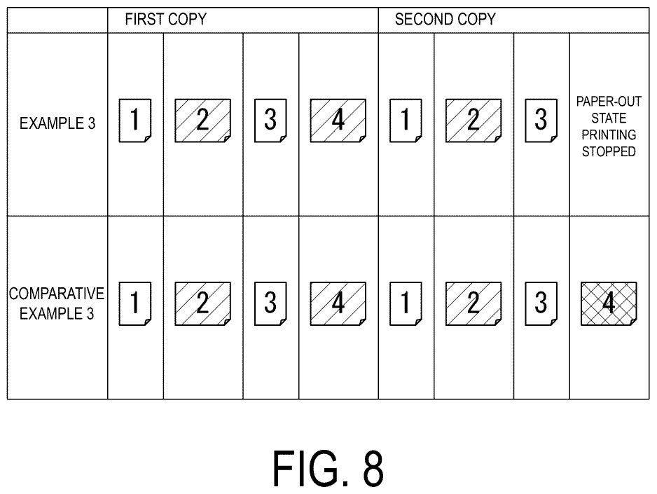

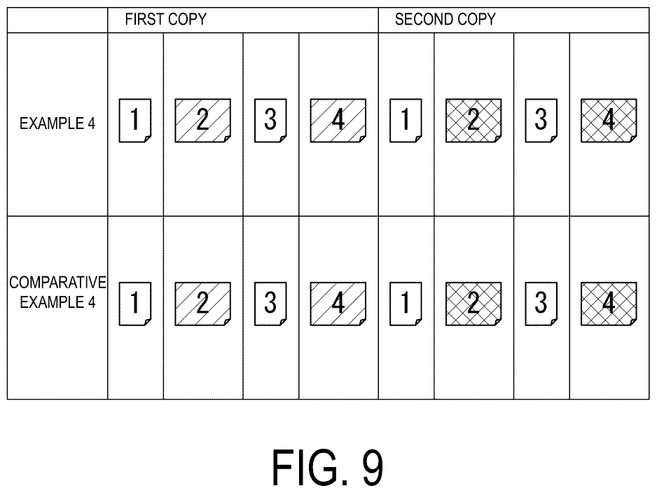

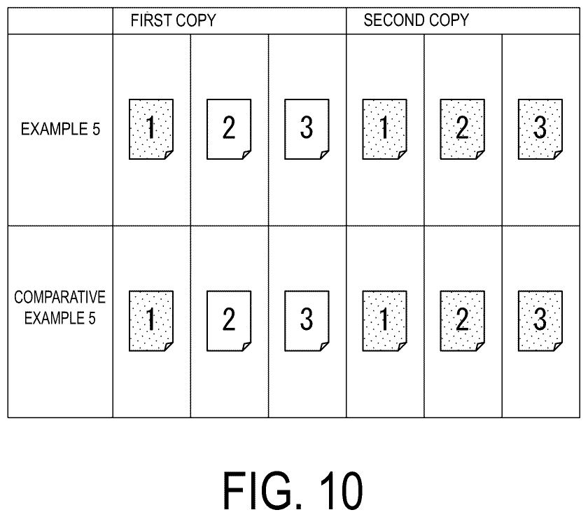

FIG. 6 is a diagram for explaining Example 1 in which the image forming apparatus according to the embodiment of the disclosure is used. FIG. 7 is a diagram for explaining Example 2 in which the image forming apparatus according to the embodiment of the disclosure is used. FIG. 8 is a diagram for explaining Example 3 in which the image forming apparatus according to the embodiment of the disclosure is used. FIG. 9 is a diagram for explaining Example 4 in which the image forming apparatus according to the embodiment of the disclosure is used. FIG. 10 is a diagram for explaining Example 5 in which the image forming apparatus according to the embodiment of the disclosure is used.

### Example 1

In Example 1, a case will be described where, in the image forming apparatus 100, the sheets P of the A4 size are held in each of the feed tray 18a and the feed tray 18b, and performing image formation (printing) on three sheets P of the A4 size is defined as one set (one copy), and an image forming instruction is issued to perform two sets (two copies). Note that the sheets held in the feed tray 18a and the sheets held in the feed tray 18b are the sheets P of the A4 size but have paper qualities different from each other. Then, it is assumed that the sheet P held in the feed tray 18a is normally fed to the image former 60, and performance of the feed tray automatic switching function is set. Further, the number of sheets P held in the feed tray 18a is four. Note that a sufficient number of the sheets P are held in the feed tray 18b.

In the image forming apparatus 100, when an image forming instruction is issued, as illustrated in FIG. 6, since three sheets are used for a first copy (first set), the sheets P held in the feed tray 18a are fed to the image former 60 and image formation is performed. However, the sheet P held in the feed tray 18a runs out since the image formation is performed on a first sheet of a second copy (second set), and the paper-out state occurs. In this case, the image forming apparatus 100 stops the image forming operation (stops printing), and the notification display 91 is displayed on the operation panel 90.

At this time, when the user desires to continue the image forming operation using the sheet P held in the feed tray 18b, by selecting “CONTINUE PRINTING” in the notification display 91, the sheet P held in the feed tray 18b is fed to the image former 60, and the image forming operation is continued.

On the other hand, when the user wants to avoid a difference in paper quality in the same set, by selecting “OK” in the notification display 91 and restocking the sheet P of the A4 size having the same paper quality as that of the sheet P held in the feed tray 18a to the feed tray 18a, the sheet P held in the feed tray 18a is fed to the image former 60 again and the image forming operation is continued.

Next, as Comparative Example 1, a case will be described where an image forming apparatus of the related art is caused to operate under the same conditions as those in Example 1. As illustrated in FIG. 6, since image formation is performed on the first sheet of the second set, the sheet held in the feed tray runs out and the paper-out state occurs. In this case, in the image forming apparatus of the related art, the feed tray is switched, and the sheet is fed from the feed tray holding the sheet of a different paper quality to the image former, and the image formation is performed. Therefore, in the second set, the first sheet is different in paper quality from the second and third sheets. In this manner, the sheets of different paper qualities are mixed in the same set. That is, when the sheets of different paper qualities are held in the respective feed trays, it is difficult to avoid mixing of the sheets of different paper qualities in the same set.

On the other hand, in the image forming apparatus 100 according to the embodiment, even when the sheets P of different paper qualities are held in the respective feed trays 18a and 18b, and performance of the feed tray automatic switching function is set, it is easy to avoid mixing of the sheets P of different paper qualities in the same set. Further, when accepted by the user, it is easy to select that the sheets P of different paper qualities are mixed in the same set.

### Example 2

In Example 2, a case will be described where, in the image forming apparatus 100, the sheets P of the A4 size are held in each of the feed tray 18a and the feed tray 18b, and image formation (printing) on three sheets P of the A4 size is defined as one set, and an image forming instruction is issued to perform two sets (two copies). Note that the sheets held in the feed tray 18a and the sheets held in the feed tray 18b are the sheets P of the A4 size but have paper qualities different from each other. Then, it is assumed that the sheet P held in the feed tray 18a is normally fed to the image former 60, and performance of the feed tray automatic switching function is set. Further, the number of sheets P held in the feed tray 18a is three, which is different from Example 1. Note that a sufficient number of the sheets P are held in the feed tray 18b.

In the image forming apparatus 100, when an image forming instruction is issued, as illustrated in FIG. 7, since three sheets are used for the first copy (first set), the sheet P held in the feed tray 18a is fed to the image former 60 and image formation is performed. Then, since image formation is performed on the third sheet of the first set, the sheet P held in the feed tray 18a runs out and the paper-out state occurs, but since the sheet P on which the image formation is performed next is the first sheet of the second set, the feed tray is switched to the feed tray 18b, the sheet P held in the feed tray 18b is fed to the image former 60, and the image forming operation is continued. As a result, the first and second sets have paper qualities different from each other, but the same set has the same paper quality. In addition, in this case, the user does not need to select a process, and the image forming operation can be efficiently performed.

Next, as Comparative Example 2, a case will be described where the image forming apparatus of the related art is caused to operate under the same conditions as those in Example 2. As illustrated in FIG. 7, since image formation is performed on the third sheet of the first set, the sheet held in the feed tray runs out and the paper-out state occurs. In this case, in the image forming apparatus of the related art, the feed tray is switched, and the sheet is fed from the feed tray holding the sheet of a different paper quality to the image former, and the image formation is performed. Therefore, even the image forming apparatus of the related art provides the same result as that of the image forming apparatus 100 according to the embodiment.

### Example 3

In Example 3, a case will be described where, in the image forming apparatus 100, the sheet P of the A4 size is held in the feed tray 18a, the sheets P of the A3 size is held in each of the feed tray 18c and the feed tray 18d, and an image forming instruction is issued to perform two sets (two copies), where performing image formation (printing) on the sheets P of the first sheet of the A4 size, the second sheet of the A3 size, the third sheet of the A4 size, and a fourth sheet of the A3 size is defined as one set. Note that the sheets held in the feed tray 18c and the sheets held in the feed tray 18d are the sheets P of the A3 size but have paper qualities different from each other. Further, it is assumed that, when there is an image forming instruction for the sheet P of the A3 size, the sheet P held in the feed tray 18c is normally fed to the image former 60, and performance of the feed tray automatic switching function is set. Further, the number of sheets P held in the feed tray 18c is three. Note that a sufficient number of the sheets P are held in the feed trays 18a and 18d.

Further, the number of sheets P held in the feed tray 18a is four or more.

In the image forming apparatus 100, when an image forming instruction is issued, as illustrated in FIG. 8, for the first copy (first set), the first sheet P is fed from the feed tray 18a to the image former 60, the second sheet P is fed from the feed tray 18c to the image former 60, the third sheet P is fed from the feed tray 18a to the image former 60, the fourth sheet P is fed from the feed tray 18c to the image former 60, image formation for the first set is completed, and the image forming operation for the second set is subsequently performed. For the second set, the first sheet P is fed from the feed tray 18a to the image former 60, and the second sheet P is fed from the feed tray 18c to the image former 60, but as a result, the sheet P held in the feed tray 18c runs out, and the paper-out state occurs. Here, since the third sheet P has the A4 size and the feed tray 18a holds the sheet P, the image forming operation is continued, and the third sheet P is fed from the feed tray 18a to the image former 60. Then, since the fourth sheet P of the A3 size is not held in the feed tray 18c, the image forming apparatus 100 stops the image forming operation (stops printing), and the notification display 91 is displayed on the operation panel 90.

At this time, in a case where the user desires to continue the image forming operation using the sheet P of the A3 size held in the feed tray 18d, by selecting “CONTINUE PRINTING” in the notification display 91, the sheet P held in the feed tray 18d is fed to the image former 60, and the image forming operation is continued. Note that the sheet P of the A3 size may be placed on a bypass tray instead of the feed tray 18d, and in this case, the sheet P placed on the bypass tray is fed to the image former 60.

On the other hand, when the user wants to avoid a difference in paper quality for the same size in the same set, by selecting “OK” in the notification display 91 and restocking the feed tray 18c with the sheet P of the A3 size having the same paper quality as that of the sheet P held in the feed tray 18c, the sheet P of the A3 size that is the fourth sheet of the second set is fed from the feed tray 18c to the image former 60 and the image forming operation is performed.

Next, as Comparative Example 3, a case will be described where the image forming apparatus of the related art is caused to operate under the same conditions as those in Example 3. As illustrated in FIG. 8, since image formation is performed on the second sheet of the second set, the sheet in the feed tray holding the sheet of the A3 size runs out, and the paper-out state occurs. In this case, in the image forming apparatus of the related art, when the sheet P of the A3 size is fed to the image former next, the feed tray is switched, and the sheet is fed from the feed tray holding the sheet of a different paper quality to the image former, and the image formation is performed. Therefore, in the second set, the first and third sheets of the A4 size have the same paper quality, but the second sheet and the fourth sheet of the A3 size have paper qualities different from each other, and thus the sheets of different paper qualities are mixed in the sheets of the same size in the same set. In this way, when the sheets of different paper qualities are held in the respective feed trays that hold the sheets of the same size, it is difficult to avoid mixing of the sheets of different paper qualities among the sheets of the same size within the same set.

On the other hand, in the image forming apparatus 100 according to the embodiment, even when the sheets P of different paper qualities are held in the respective feed trays 18c and 18d that hold the sheets P of the same size, and performance of the feed tray automatic switching function is set, it is easy to avoid mixing of different paper qualities in the sheets P of the same size in the same set. Further, when accepted by the user, it is easy to select that different paper qualities are mixed in the sheets P of the same size in the same set.

### Example 4

In Example 4, a case will be described where, in the image forming apparatus 100, the sheet P of the A4 size is held in the feed tray 18a, the sheets P of the A3 size is held in each of the feed tray 18c and the feed tray 18d, and an image forming instruction is issued to perform two sets (two copies), where performing image formation (printing) on the sheets P of the first sheet of the A4 size, the second sheet of the A3 size, the third sheet of the A4 size, and the fourth sheet of the A3 size is defined as one set. Note that the sheets held in the feed tray 18c and the sheets held in the feed tray 18d are the sheets P of the A3 size but have paper qualities different from each other. Then, it is assumed that, when there is an image forming instruction for the sheet P of the A3 size, the sheet P held in the feed tray 18c is normally fed to the image former 60, and performance of the feed tray automatic switching function is set. Further, the number of sheets P held in the feed tray 18c is two, which is different from Example 3. Note that a sufficient number of the sheets P are held in the feed trays 18a and 18d.

In the image forming apparatus 100, when an image forming instruction is issued, as illustrated in FIG. 9, for the first copy (first set), the first sheet P is fed from the feed tray 18a to the image former 60, the second sheet P is fed from the feed tray 18c to the image former 60, the third sheet P is fed from the feed tray 18a to the image former 60, the fourth sheet P is fed from the feed tray 18c to the image former 60, and image formation for the first set is completed. Here, the fourth sheet P is fed from the feed tray 18c to the image former 60, and thus the sheet P held in the feed tray 18c runs out, and the paper-out state occurs. In this case, since the sheet P of the A3 size is fed next not for the first set but the second set, when the sheet P of the A3 size is fed next to the image former 60, switching is performed and the sheet P of the A3 size is fed from the feed tray 18d to the image former 60.

For the second copy (second set), the first sheet P is fed from the feed tray 18a to the image former 60, the second sheet P is fed from the feed tray 18d to the image former 60, the third sheet P is fed from the feed tray 18a to the image former 60, the fourth sheet P is fed from the feed tray 18d to the image former 60, and thus image formation for the second set is completed.

As a result, for the sheets P of the A3 size, the first and second sets have paper qualities different from each other, but the same set has the same paper quality. In addition, in this case, the user does not need to select a process, and the image forming operation can be efficiently performed.

Next, as Comparative Example 4, a case will be described where the image forming apparatus of the related art is caused to operate under the same conditions as those in Example 4. As illustrated in FIG. 9, since image formation is performed on the fourth sheet of the first set, the sheet of the A3 size held in the feed tray runs out and the paper-out state occurs. In this case, in the image forming apparatus of the related art, switching to another feed tray holding the sheet of the A3 size is performed, and the sheet is fed from the feed tray holding the sheet of a paper quality different from that of the sheet of the A3 size of the first set to the image former, and image formation is performed. Therefore, even the image forming apparatus of the related art provides the same result as that of the image forming apparatus 100 according to the embodiment.

### Example 5

In Example 5, a case will be described where, in the image forming apparatus 100, the sheets P of the A4 size are held in each of the feed tray 18a and the feed tray 18b, performing image formation (printing) on three sheets P of the A4 size is defined as one set, and an image forming instruction is issued to perform two sets (two copies), and the sheet P for which the cover sheet setting is made is used for the first sheet of each set. Note that the sheets held in the feed tray 18a and the sheets held in the feed tray 18b are the sheets P of the A4 size but have paper qualities different from each other. Then, it is assumed that the sheet P held in the feed tray 18a is normally fed to the image former 60, and performance of the feed tray automatic switching function is set. Further, it is set that the sheet P for which the cover sheet setting is made, and that is used as a cover sheet (cover setting is made) is the sheet P held in the feed tray 18b. Further, the number of sheets P held in the feed tray 18a is two. Note that a sufficient number of the sheets P are held in the feed tray 18b.

In the image forming apparatus 100, when an image forming instruction is issued, as illustrated in FIG. 10, since the first sheet serves as the cover sheet for the first copy (first set), as the first sheet, the sheet P held in the feed tray 18b is fed to the image former 60 and image formation is performed. Then, as the second and third sheets, the sheets P held in the feed tray 18a are fed to the image former 60 and image formation is performed, and the image formation for the first set is completed. Here, since the third sheet P is fed from the feed tray 18a to the image former 60, the sheet P held in the feed tray 18a runs out and the paper-out state occurs, but the operation proceeds to image formation for the second copy (second set). For the second set, since the first sheet serves as the cover sheet, as the first sheet, the sheet P held in the feed tray 18b is fed to the image former 60 and image formation is performed. Then, although the sheet P held in the feed tray 18a runs out, the image forming operation is continued without being stopped, and also as the second sheet and the third sheet that are not the cover sheet, the sheets P are fed from the feed tray 18b to the image former 60 and the image formation is performed. This eliminates the need for the user to select a process, and the image forming operation can be efficiently performed.

Next, as Comparative Example 5, a case will be described where the image forming apparatus of the related art is caused to operate under the same conditions as those in Example 5. As illustrated in FIG. 10, since image formation is performed on the third sheet of the first set, the sheet other than the cover sheet held in the feed tray runs out and the paper-out state occurs. In this case, in the image forming apparatus of the related art, the feed tray is switched, and the sheet is fed from the feed tray holding the sheet for the cover sheet to the image former, and the image formation is performed. Therefore, even the image forming apparatus of the related art provides the same result as that of the image forming apparatus 100 according to the embodiment.

The disclosure is not limited to the embodiments described above and can be implemented in various other forms. Thus, the above embodiments are merely examples in all respects and should not be interpreted as limiting. The scope of the disclosure is indicated by the claims, and is not restricted by the description in the specification. Furthermore, all modifications and alterations falling within the equivalent scope of the claims are included within the scope of the disclosure.

### REFERENCE SIGNS LIST

1 Optical scanning apparatus
2 Development apparatus
3 Photoreceptor drum
4 Drum cleaning apparatus
5 Charger
6 Intermediate transfer roller
9 Cleaning apparatus
11 Secondary transfer apparatus
11a Secondary transfer roller
12 Fixing apparatus
13 Conveying roller
14 Registration roller
16a to 16d Pickup roller
17 Discharge roller
18a to 18d Feed tray
19a to 19d Sheet sensor
31 Fixing roller
32 Pressure roller
50 Image transferrer
60 Image former (image forming device)
80 Sheet feeder (sheet feeding device)
90 Operation panel (display device)
91 Notification display (display regarding handling method)
70 Intermediate transfer belt apparatus
71 Intermediate transfer belt
72 Intermediate transfer driving roller
73 Intermediate transfer driven roller
100 Image forming apparatus
101 Image forming apparatus body
102 Image reading apparatus
130 Image reader
130a Document table
130b Document reader
130c Scanning optical system
140 Discharge portion
141 Sheet discharge tray
160 Document feeding apparatus
161 Document placement tray
162 Document discharge tray
180 Controller
181 Processor
182 Storage
183 Image forming operation determiner
Sr Sheet reverse path
S Sheet conveyance path
TN Transfer nip region
G Document
P Sheet
P1 Feeding path
Pa, Pb, Pc, Pd Image stationClaims

1. An image forming apparatus, comprising:
an image forming device that forms an image on a sheet;
a plurality of feed trays each holding the sheet; and
a sheet feeding device that draws out the sheet one at a time from the feed tray and feeds the sheet to the image forming device, wherein
in a case where an image forming instruction is input to perform image formation for a plurality of sets in each of which image formation is performed on a plurality of the sheets, the sheet feeding device feeds the sheet from a predetermined feed tray to the image forming device,
in a case where the sheet held in the predetermined feed tray runs out in the middle of the image formation in the image forming instruction, the image forming device stops image forming operation, and
in a case where a final sheet of a predetermined set in the image forming instruction is fed to the image forming device, and the sheet in the predetermined feed tray runs out, the sheet feeding device feeds the sheet from another feed tray different from the predetermined feed tray to the image forming device and the image forming device continues the image forming operation.

2. The image forming apparatus according to claim 1, wherein
cover sheet setting to set a first sheet as a cover sheet in a case where image formation is performed on the plurality of sheets is allowed,
in a case where the image forming instruction is input to perform the image formation for a plurality of sets in each of which the image formation is performed on the plurality of sheets for which the cover sheet setting is made, the sheet feeding device feeds the sheet from a predetermined feed tray to the image forming device, and
in a case where, in the middle of the image formation in the image forming instruction, the sheet held in the predetermined feed tray runs out due to the sheet on which the image formation is performed as the cover sheet being fed from the predetermined feed tray, the sheet feeding device feeds the sheet from another feed tray different from the predetermined feed tray to the image forming device, and the image forming device continues the image forming operation.

3. An image forming apparatus, comprising:
an image forming device that forms an image on a sheet;
a plurality of feed trays each holding the sheet; and
a sheet feeding device that feeds the sheet one at a time from the feed tray and feeds the sheet to the image forming device, wherein
the plurality of feed trays include a plurality of combinations of the plurality of feed trays, the combination holding the plurality of sheets of an identical size, and the sheet of a different size is held in the feed tray of a different combination,
in a case where an image forming instruction is input to perform image formation for a plurality of sets in each of which the image formation is performed on the plurality of sheets in which the plurality of sheets of a plurality of sizes different from each other are mixed, the sheet feeding device feeds the sheet from a predetermined feed tray to the image forming device according to the size of the sheet in the image forming instruction, and
in a case where, in the middle of the image formation for a predetermined set in the image forming instruction, the sheet held in the predetermined feed tray runs out, and the image formation on the sheet of an identical size to that of the sheet running out is not ended, the image forming device stops image forming operation.

4. The image forming apparatus according to claim 3, wherein
in a case where, in the middle of the image formation for the predetermined set in the image forming instruction, the sheet held in the sheet tray in the predetermined feed tray runs out, and the image formation on the sheet of an identical size to that of the sheet running out is ended, the sheet feeding device feeds the sheet to the image forming device from another feed tray that is different from the predetermined feed tray and holds the sheet of an identical size, and the image forming device continues the image forming operation.

5. The image forming apparatus according to claim 1, comprising a display device, wherein
in a case where the image forming device stops the image forming operation in the middle of the image formation, the display device performs display relating to a handling method.
